(19) United States
(12) Patent Application Publication
(10) Pub. No.: US 2026/0048810 A1
(43) Pub. Date: Feb. 19, 2026

(54) ELECTRIC MOTORCYCLE

(71) Applicant: BOMBARDIER RECREATIONAL PRODUCTS INC., Valcourt (CA)

(72) Inventors: Jonathan ROY, Sherbrooke (CA); Martin HEON, Sherbrooke (CA); Jeremie DUFORD, Sherbrooke (CA)

(21) Appl. No.: 19/298,803

(22) Filed: Aug. 13, 2025

Related U.S. Application Data
(60) Provisional application No. 63/682,867, filed on Aug. 14, 2024.

(51) Int. Cl. B62K 25/00; B62J 25/06; B62J 43/16; B62K 11/04

(52) U.S. Cl. CPC B62K 25/005; B62J 25/06; B62J 43/16; B62K 11/04; B62K 2204/00

(57) ABSTRACT

An electric motorcycle including a frame; a battery pack including a battery housing forming a portion of the frame; a swingarm connected to the battery housing; footrest supports connected to the battery housing; footrests supported by the footrest supports; and a swingarm pivot fastener extending through each footrest support, the swingarm pivot fasteners connecting the footrest supports and the swingarm to the battery housing. In some embodiments, the motorcycle also includes a swingarm connection assembly connected to the battery housing. The swingarm is connected to the swingarm connection assembly; the at least one swingarm pivot fastener extends through the at least one footrest support and at least partially into the swingarm connection assembly; and the at least one swingarm pivot fastener connects the at least one footrest support and the swingarm to the battery housing through the swingarm connection assembly.

### CROSS-REFERENCE

The present application claims priority to U.S. Provisional Patent Application No. 63/682,867, entitled “Electric Motorcycle,” filed Aug. 14, 2024, the entirety of which is incorporated by reference herein.

### FIELD OF TECHNOLOGY

The present technology relates to electric motorcycles with footrests.

### BACKGROUND

Straddle seat vehicles, including motorcycles, all-terrain vehicles, and snowmobiles, are popular transport and recreational vehicles. As the move toward electrification of vehicles progresses, interest in electric versions of straddle seat vehicles, including electric motorcycles, increases.

Motorcycle footrests must provide sufficient stiffness to support the force exerted by the rider's mass, which can increase substantially in certain driving conditions, for instance when jumping or encountering potholes. The footrests should thus be connected to and/or supported by structural portions of the motorcycle.

In electric motorcycles, much of the vehicle space may be occupied by the battery pack. A structural connection of the footrests in the vehicle thus must be designed not only for proper placement of the feet of the driver, but with attention to forces applied to the battery pack.

There is therefore a desire for arrangements of electric motorcycles addressing at least some of the above-described disadvantages.

### SUMMARY

It is an object of the present technology to ameliorate at least some of the inconveniences present in the prior art.

According to aspects of the present technology, there is provided an electric motorcycle having a structural battery pack, with the housing thereof providing a forward portion of the frame. A swingarm supporting the rear wheel is pivotably connected to the battery housing. The motorcycle includes driver footrests connected to footrest supports to provide structure to the footrests. The footrest supports are connected to the battery pack at the pivot axis of the swingarm. Pivot fasteners extend through the footrest supports and fasten the swingarm to the battery pack. In some embodiments, the footrest supports and the swingarm are fastened to the battery pack housing via a swingarm connection assembly. The swingarm connection assembly acts as a mechanical fuse to provide a breaking point between the battery pack and the swingarm in the event of an accident or an excess of forces. Connection of the footrest supports to the swingarm connection assembly provides stiffness and strength to support the forces exerted upon the footrests.

According to one aspect of the present technology, there is provided an electric motorcycle including a frame; a battery pack including a battery housing, the battery housing forming a portion of the frame; a front ground-engaging element operatively connected to the frame; a swingarm connected to the battery housing; a rear ground-engaging element operatively connected to the swingarm; at least one footrest support connected to the battery housing; at least one footrest supported by the at least one footrest support; and at least one swingarm pivot fastener extending through the at least one footrest support, the at least one swingarm pivot fastener connecting the at least one footrest support and the swingarm to the battery housing.

In some embodiments, the electric motorcycle further includes a swingarm connection assembly connected to the battery housing; and wherein the swingarm is connected to the swingarm connection assembly; the at least one swingarm pivot fastener extends through the at least one footrest support and at least partially into the swingarm connection assembly; and the at least one swingarm pivot fastener connects the at least one footrest support and the swingarm to the battery housing through the swingarm connection assembly.

In some embodiments, the swingarm connection assembly is made of steel.

In some embodiments, the swingarm connection assembly comprises a left swingarm connection plate and a right swingarm connection plate.

In some embodiments, the left swingarm connection plate and the right swingarm connection plate form a mechanical fuse connection between the battery housing and the swingarm.

In some embodiments, the at least one footrest support includes a right footrest support connected to the right swingarm connection plate, and a left footrest support connected to the left swingarm connection plate; and the at least one footrest includes a right footrest connected to the right footrest support, and a left footrest connected to the left footrest support.

In some embodiments, the at least one swingarm pivot fastener includes a right side pivot fastener connecting the right footrest support and the swingarm to a right side of the battery housing through the right swingarm connection plate; and a left side pivot fastener connecting the left footrest support and the swingarm to a left side of the battery housing through the left swingarm connection plate.

In some embodiments, the swingarm is received laterally between the right swingarm connection plate and left swingarm connection plate.

In some embodiments, the electric motorcycle further includes an electric motor mounted on the swingarm, the electric motor being electrically connected to the battery pack, the electric motor being operatively connected to the rear ground-engaging element for driving the rear ground-engaging element during use.

In some embodiments, the at least one swingarm pivot fastener is at least one screw.

In some embodiments, the at least one swingarm pivot fastener is at least one bolt.

In some embodiments, the at least one footrest support is made of aluminum.

For the purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight-ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an electric motorcycle according to non-limiting embodiments of the present technology;

FIG. 2 is a rear, left side perspective view of the motorcycle of FIG. 1, with fairings and some other components removed to reveal a frame structure of the motorcycle;

FIG. 3 is a top plan view of the motorcycle frame structure of FIG. 2;

FIG. 4 is a left side elevation view of the motorcycle frame structure of FIG. 2, with a footrest and footrest support shown in an exploded view;

FIG. 5 is a bottom, front, left side perspective view of the motorcycle frame structure of FIG. 2, with a footrest and footrest support shown in an exploded view;

FIG. 6 is a top, left side perspective view of the motorcycle frame structure of FIG. 2, with a footrest and footrest support shown in an exploded view;

FIG. 7 is a top, left, rear perspective, exploded view of a battery pack, swingarm, and footrest assemblies of the motorcycle of FIG. 1;

FIG. 8 is a close-up, partial view of the motorcycle portions of FIG. 7;

FIG. 9 is another top, left, rear perspective, exploded view of a battery pack, swingarm, and footrest assemblies of the motorcycle of FIG. 1; and

FIG. 10 is a top, left, rear perspective, exploded view of swingarm connection plates and footrest assemblies of the motorcycle of FIG. 1.

It should be noted that, unless otherwise explicitly specified herein, the drawings are not necessarily to scale.

### DETAILED DESCRIPTION

The present technology will be described herein with respect to electric motorcycles, specifically a two-wheeled electric motorcycle 100. While the motorcycle 100 illustrated herein is a trail or sport style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

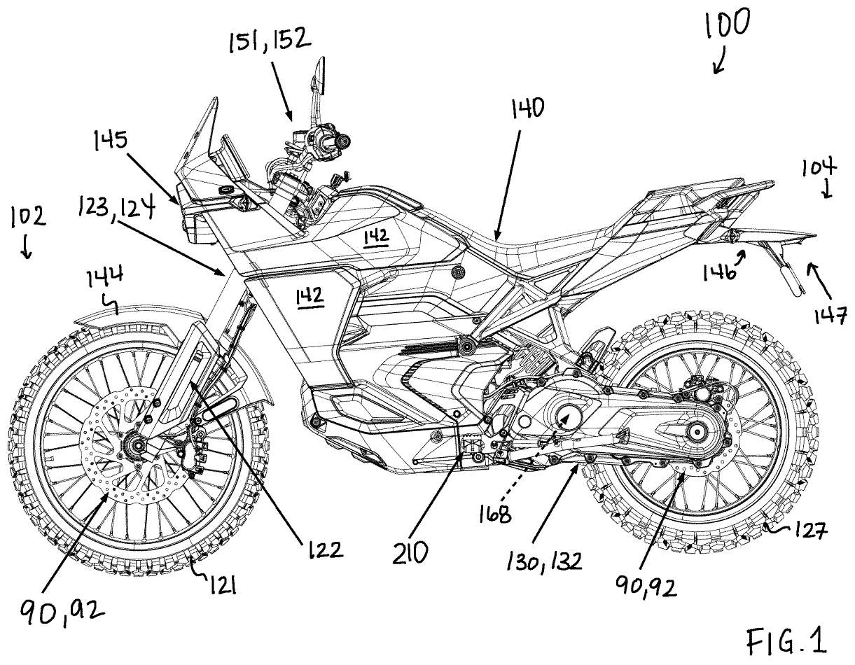

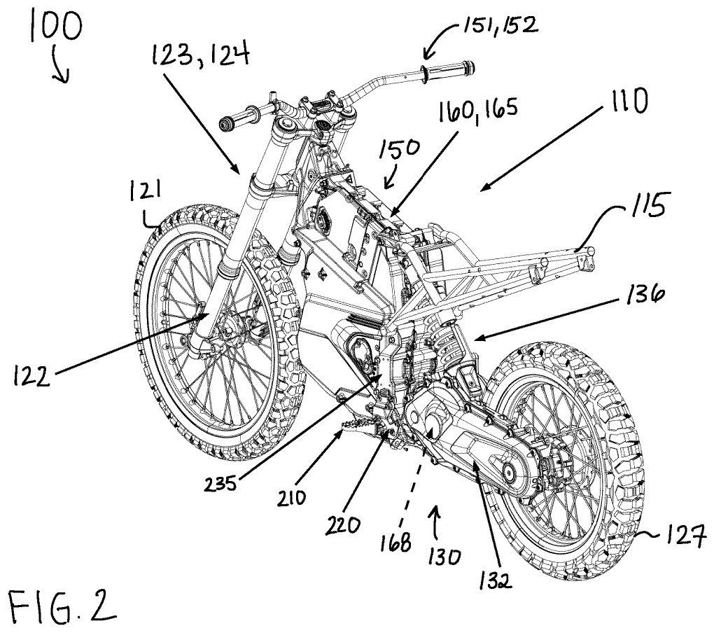

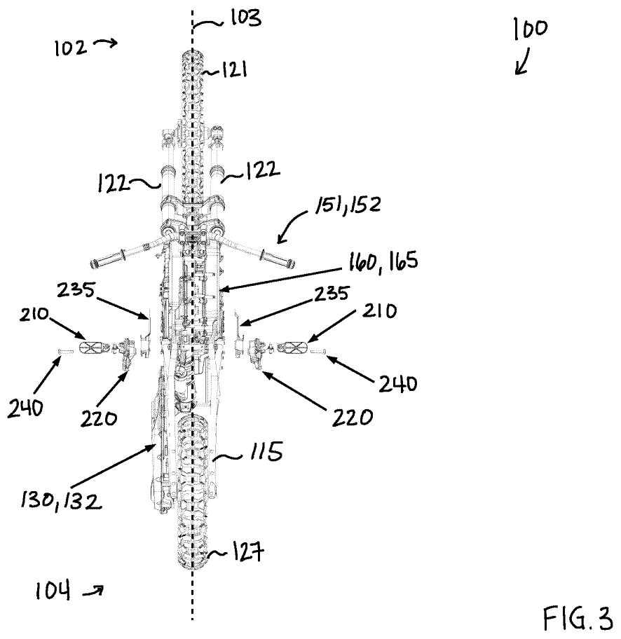

With reference to FIGS. 1 to 3, the electric motorcycle 100, also referred to herein as the vehicle 100, has a front end 102, a rear end 104, and a centerplane 103 defined consistently with the forward travel direction of the vehicle 100. The vehicle 100 includes a front wheel 121 and a rear wheel 127. The front wheel 121 and the rear wheel 127 each have a tire secured thereto. The front wheel 121 and the rear wheel 127 are centered with respect to the longitudinal centerplane 103.

The vehicle 100 includes an electronic powerpack 150 for powering the vehicle 100. The powerpack 150 includes a battery pack 160, a charger (not shown), and an inverter (not shown). Also referred to as an energy storage system (ESS) or battery energy storage system (BESS), the battery pack 160 includes a battery pack housing 165, referred to herein as the housing 165. The battery pack 160 is arranged in the vehicle 100 such that the battery pack 160 and the battery pack housing 165 are disposed longitudinally between the front wheel 121 and the rear wheel 127. A top most point of the battery pack 160 and the battery pack housing 165 are vertically higher than the front wheel 121 and the rear wheel 127. A bottom most point of the battery pack 160 and the battery pack housing 165 are vertically lower than a rotation axis of the front wheel 121 and a rotation axis of the rear wheel 127.

The vehicle 100 includes a frame 110 providing the central structure of the vehicle 100. By the present technology, the battery pack housing 165 forms a portion of the frame 110. The frame 110 further includes a rear frame structure 115 connected to the housing 165. It is contemplated that the specific shape and size of the housing 165 and the rear frame structure 115 could vary in different embodiments.

The front wheel 121 is connected to the frame 110 by a front suspension assembly 123, the front wheel 121 being rotationally connected to the front suspension assembly 123. The front suspension assembly 123 includes a front fork assembly 124 for supporting the front end 102 of the vehicle 100. The front fork assembly 124 includes a pair of front shocks 122, with the front wheel 121 connected to a bottom portion of the pair of front shocks 122.

The vehicle 100 includes a handlebar assembly 152 operatively connected to the front fork assembly 124. The handlebar assembly 152 forms a portion of a steering assembly 151 and is used by the rider to turn the front wheel 121, via the front fork assembly 124, to steer the vehicle 100. A twist-grip throttle (not shown) is operatively connected on the right side of the handlebar assembly 152 for controlling vehicle speed. It is contemplated that the twist-grip throttle could be replaced by a thumb throttle lever or some other type of throttle input device. The twist-grip throttle could be disposed on the left side of the handlebar assembly 152 in some embodiments. The handlebar assembly 152 also includes a brake lever (not shown) on a right side for activating the brake assemblies 90.

The vehicle 100 further includes an electric motor 168 for driving the vehicle 100, specifically the rear wheel 127. The vehicle 100 includes a swingarm 132, with the rear wheel 127 being rotationally connected to the swingarm 132. The motor 168 is disposed in the swingarm 132 in the present embodiment. It is contemplated that the motor 168 could be differently arranged in some embodiments. Electric power is provided to the motor 168 by the electronic powerpack 150, the motor 168 being operatively connected to the battery pack 160. The motor 168 drives the rear wheel 127 via a transmission assembly (not shown) disposed in the swingarm 132. In the present embodiment, the motor 168 is a three-phase electric motor 168. It is contemplated that different types of motors could be used in some embodiments.

Returning to FIG. 1, the vehicle 100 includes a straddle seat 140 disposed along the longitudinal centerplane 103. The straddle seat 140 is connected to and supported by the frame 110. In the illustrated implementation, the straddle seat 140 is intended to accommodate a single adult-sized rider, i.e. the driver. It is however contemplated that the seat 140 could be longer or that a passenger seat portion could be connected to the frame 110 rearward of the seat 140 in order to accommodate a passenger behind the driver. Depending on the particular implementation, it is also contemplated that the seat 140 could be supported by body panels of the vehicle 100.

The vehicle 100 also includes a rear suspension assembly 130. The rear suspension assembly 130 includes the swingarm 132 and a shock absorber 136. As is mentioned above, the motor 168 and the drivetrain connecting the motor 168 to the rear wheel 127 are disposed in the swingarm 132. The swingarm 132 is pivotally mounted at a front thereof to the battery pack 160. The swingarm connection is described in more detail below. The rear wheel 127 is rotatably mounted to the rear end of the swingarm 132 which extends on a left side of the rear wheel 127. The shock absorber 136 is connected between the swingarm 132 and the frame 110. It is contemplated that the relative arrangement of the shock absorber 136 and the rear wheel 127 to the swingarm 132 could vary in different embodiments.

The vehicle 100 further includes a plurality of body panels 142 for forming the body of the vehicle 100, illustrated in FIG. 1. The body panels 142 are connected to and supported by the frame 110, the battery pack housing 165, and/or the rear suspension assembly 136. The body panels 142 enclose and protect some internal components of the vehicle 100 such as a powerpack 150, while helping to improve vehicle 100 aerodynamic behavior. The vehicle 100 also includes a front fender 144 disposed at the front of the vehicle 100 and extending partially over the front wheel 121. Rearward of the seat 140, the vehicle 100 also has rear fender panels 146 extending at least partially over rear wheel 127 and supporting the vehicle license plate. The vehicle 100 includes front headlights 145 attached to the front fork assembly 124 and electrically connected to the battery pack 160. The vehicle 100 also has rear braking and indicator lights 147 supported by the rear panels 146 and electrically connected to the battery pack 150.

Depending on the particular embodiment, especially between different motorcycle types (trail-style motorcycle or street-style motorcycle for example), the body panels 142 and the fenders 144, 146 could be different in shape and number. For example, some embodiments of the vehicle 100 could include a mud flap connected to a rear edge of one of the body panels 142. It is further contemplated that one or both of the fenders 144 and rear panels 146 could be omitted in some cases.

As is seen in FIG. 1, each of the front wheel 121 and the rear wheel 127 is provided with a brake assembly 90. The brake assemblies 90 of the wheels 121, 127, along with the brake pedal (not shown), form part of a brake system 92. Each brake assembly 90 is a disc-type brake mounted onto the spindle of the respective wheel 121 or 127. Other types of brakes are contemplated. The brake pedal, as well as a brake lever (not shown) disposed on the handlebar 152, are operatively connected to the brake assemblies 90 provided on each of the front wheel 121 and the rear wheel 127. The brake system 92 further includes a regenerative braking system (not shown) that uses the electric motor 168 as a generator to charge battery cells of the battery pack 160 while slowing the vehicle 100.

It is contemplated that the vehicle 100 could include a variety of different features excluded from discussion here, including but not limited to: a windscreen, radio and/or navigational systems, and luggage rack systems.

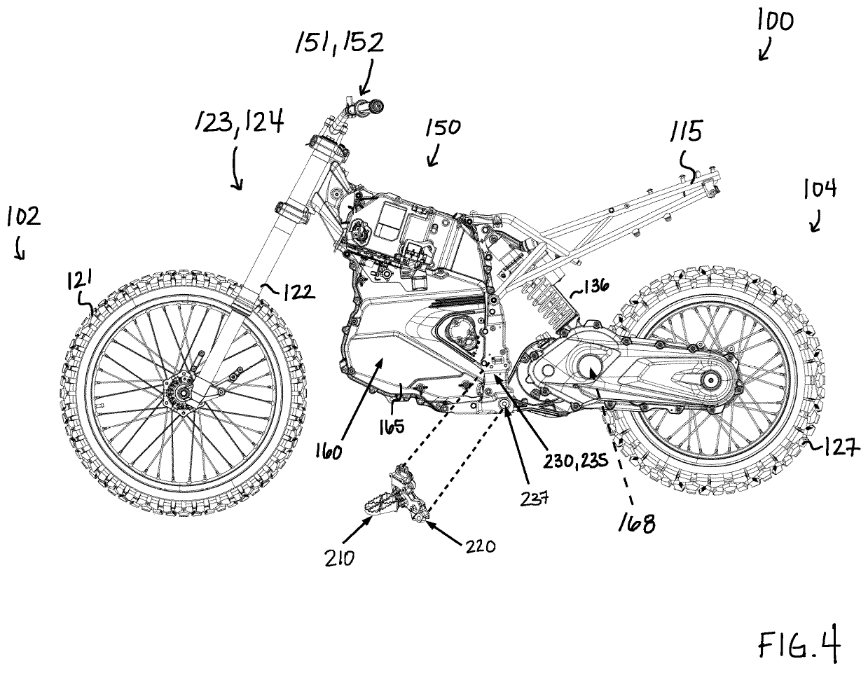

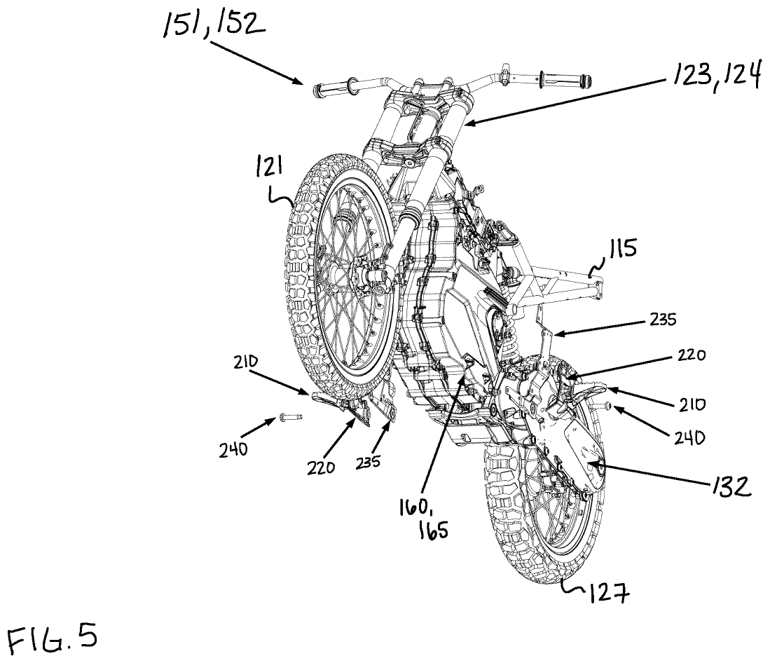

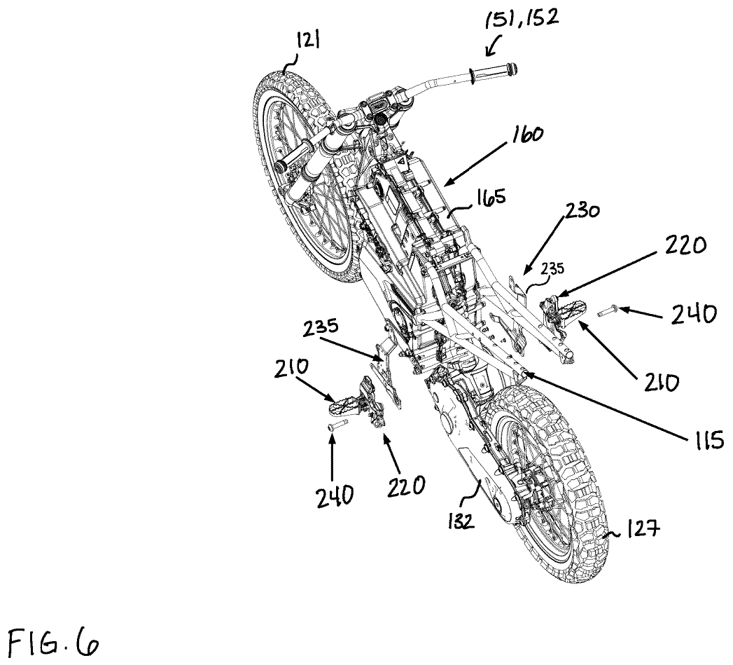

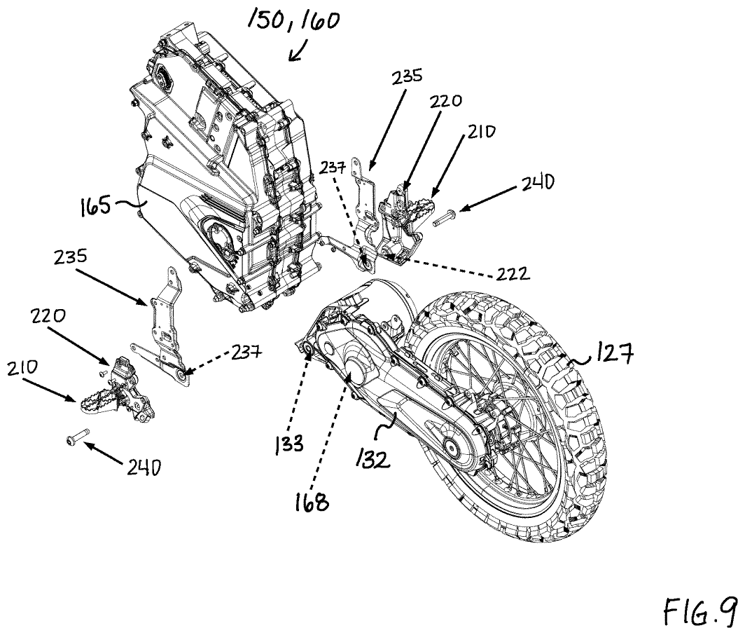

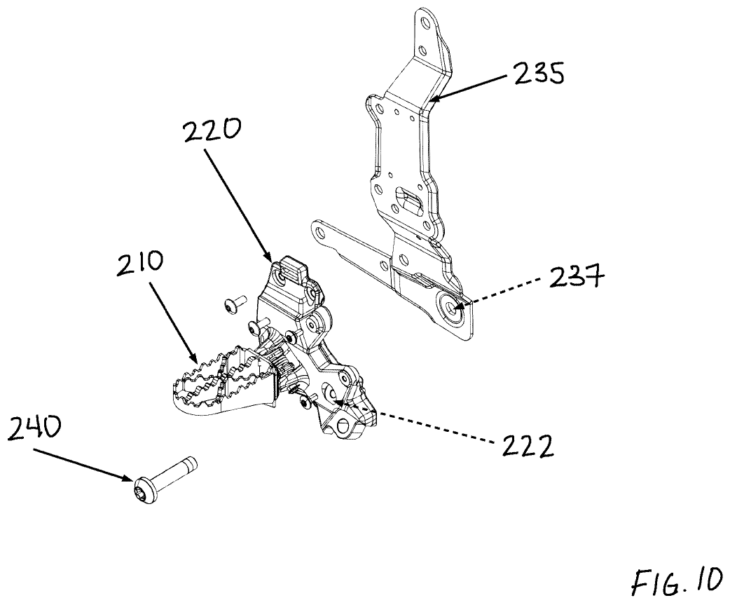

With reference to FIGS. 4 to 10, the vehicle 100 further includes a right footrest 210 disposed on the right side of the vehicle 100 and a left footrest 210 disposed on the left side of the vehicle 100. Each footrest 210 is disposed vertically lower than the straddle seat 140 to support the driver's feet. It is contemplated that the footrests 210 could be implemented in various forms other than those illustrated, including but not limited to pegs and footboards. It is contemplated that the vehicle 100 could also be provided with one or more passenger footrests disposed rearward of the driver footrest 210 on each side of the vehicle 100, for supporting a passenger's feet when a passenger seat portion for accommodating a passenger is connected to the vehicle 100. A brake pedal (not shown) is disposed forward of the right driver footrest 210 such that the driver can actuate the brake pedal with a front portion of the right foot while a rear portion of the right foot remains on the right driver footrest 210.

According to the present technology, the vehicle 100 further includes a right footrest support 220 and a left footrest support 220 for connecting to the right and left footrest 210 to the frame 110, respectively. The right footrest support 220 and the left footrest support 220 are specifically connected to the battery pack housing 165, as will be described in more detail below. In the illustrated embodiment, the footrests 210 and the footrest supports 220 are made of aluminum, but other materials are contemplated. The footrests 210 are pivotally fastened to the footrest supports 220, although it is contemplated that the footrests 210 and the supports 220 could be integrally formed in some embodiments.

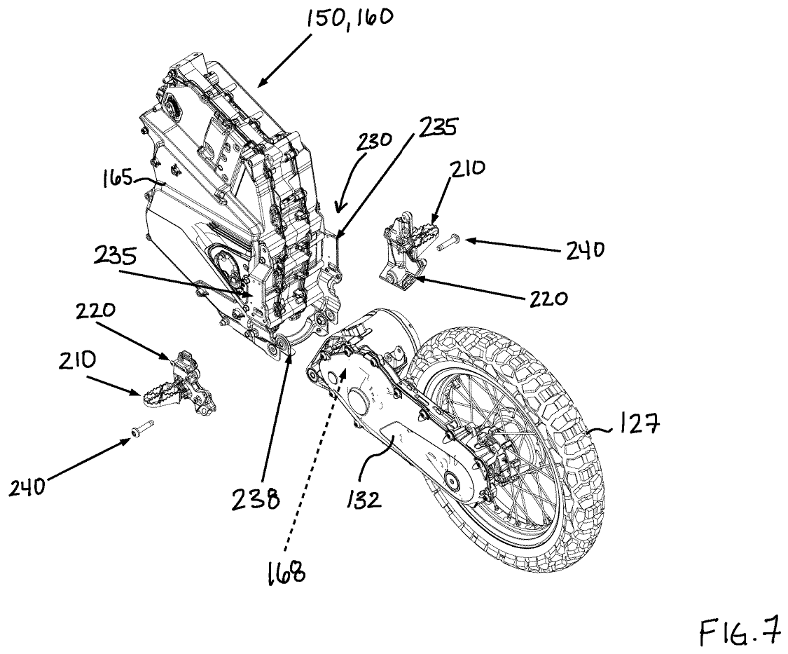

In the illustrated embodiment, the vehicle 100 also includes a swingarm connection assembly 230 connecting the swingarm 132 to the battery housing 165. The swingarm connection assembly 230 includes a right swingarm connection plate 235 and a left right swingarm connection plate 235. It is contemplated that the right and left plates 235 could be integrally connected in some embodiments. The swingarm 132 is received laterally between the right and left swingarm connection plates 235. The swingarm connection assembly 230 also includes, in at least some embodiments, a support plate 238 extending from the right side of the front of the swingarm 132, underneath the forward portion of the swingarm 132, and around to a left side thereof (see FIG. 7). In the present embodiment, the swingarm connection assembly 230 is made of steel. It is also contemplated that the swingarm connection assembly 230, or components thereof, could be made from different materials.

The left swingarm connection plate 235 and the right swingarm connection plate 235 form a mechanical fuse connection between the battery housing 165 and the swingarm 132. The swingarm connection plates 235 serve, at least in part, as mechanical fuses to aid in protecting the battery pack 150, where excessive loads from the rear suspension assembly 130 will break the plates 235 before damaging the battery pack 150. While the battery pack 150, and more specifically the battery pack housing 165, is configured and arranged to bear mechanical loads during standard use of the vehicle 100, the plates 235 serve as designed break points for excessive forces (outside of the range of standard use) as the plates 235 are more easily and more cheaply replaced than a damaged battery pack 150.

The vehicle 100 further includes two swingarm pivot fasteners 240 for pivotally connecting the swingarm 132 to the battery housing 165, via the swingarm connection assembly 230. It is contemplated that in some embodiments, only one fastener 240 could be used. For example, a pivoting post could be used in cooperation with the fastener 240 to permit the swingarm 132 to pivot relative to the battery pack 160.

In the illustrated embodiment, the swingarm pivot fasteners 240 are bolts. It is also contemplated that other fasteners, such as screws, could be used for the swingarm pivot fasteners 240 in different embodiments.

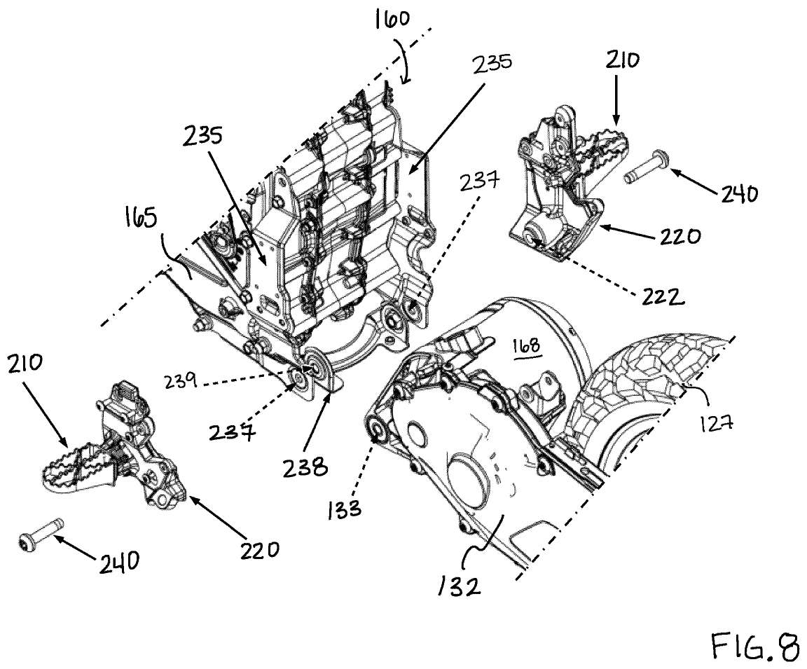

The swingarm pivot fasteners 240 also connect the footrest supports 220 to the battery housing 165. As can be seen from at least FIG. 8, each fastener 240 extends through a through-hole 222 in the footrest support 220, a through-hole 237 in the swingarm plate 235, a through-hole 239 in the support plate 238, and into the opening 133 in a forward portion of the swingarm 132. The fasteners 240 thus connect the footrest supports 220 and the swingarm 132 to the battery housing 165. The footrest supports 220 are additionally connected to the swingarm plate 235 by a plurality of other fasteners, but the specific configuration could vary. Through the stacked, or sandwiched, connection of the footrest supports 220 to the battery pack housing 165 through the swingarm plates 235, the rigidity of the swingarm plates 235 is improved. While the force required to break the swingarm plates 235 in its use as a mechanical fuse is generally unaffected, the footrest supports 220 aid in stabilizing the swingarm plates 235 during operation of the vehicle 100, aiding to reduce flex and temporary deformation.

According to the present technology, the swingarm connection assembly 230 connects the footrest supports 220 and the swingarm 132 to the battery housing 165. In some embodiments, it is contemplated that the assembly 230 could be omitted. In such a case, the fasteners 240 could connect the footrest supports 220 and the swingarm 132 directly to the battery housing 165.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. An electric motorcycle comprising:
a frame;
a battery pack including a battery housing, the battery housing forming a portion of the frame;
a front ground-engaging element operatively connected to the frame;
a swingarm connected to the battery housing;
a rear ground-engaging element operatively connected to the swingarm;
at least one footrest support connected to the battery housing;
at least one footrest supported by the at least one footrest support; and
at least one swingarm pivot fastener extending through the at least one footrest support,
the at least one swingarm pivot fastener connecting the at least one footrest support and the swingarm to the battery housing.

2. The electric motorcycle of claim 1, further comprising a swingarm connection assembly connected to the battery housing; and
wherein:
the swingarm is connected to the swingarm connection assembly;
the at least one swingarm pivot fastener extends through the at least one footrest support and at least partially into the swingarm connection assembly; and
the at least one swingarm pivot fastener connects the at least one footrest support and the swingarm to the battery housing through the swingarm connection assembly.

3. The electric motorcycle of claim 2, wherein the swingarm connection assembly is made of steel.

4. The electric motorcycle of claim 2, wherein the swingarm connection assembly comprises a left swingarm connection plate and a right swingarm connection plate.

5. The electric motorcycle of claim 4, wherein the left swingarm connection plate and the right swingarm connection plate form a mechanical fuse connection between the battery housing and the swingarm.

6. The electric motorcycle of claim 4, wherein:
the at least one footrest support includes:
a right footrest support connected to the right swingarm connection plate, and
a left footrest support connected to the left swingarm connection plate; and
the at least one footrest includes:
a right footrest connected to the right footrest support, and
a left footrest connected to the left footrest support.

7. The electric motorcycle of claim 6, wherein the at least one swingarm pivot fastener includes:
a right side pivot fastener connecting the right footrest support and the swingarm to a right side of the battery housing through the right swingarm connection plate; and
a left side pivot fastener connecting the left footrest support and the swingarm to a left side of the battery housing through the left swingarm connection plate.

8. The electric motorcycle of claim 6, wherein the swingarm is received laterally between the right swingarm connection plate and left swingarm connection plate.

9. The electric motorcycle of claim 1, further comprising an electric motor mounted on the swingarm, the electric motor being electrically connected to the battery pack, the electric motor being operatively connected to the rear ground-engaging element for driving the rear ground-engaging element during use.

10. The electric motorcycle of claim 1, wherein the at least one swingarm pivot fastener is at least one screw.

11. The electric motorcycle of claim 1, wherein the at least one swingarm pivot fastener is at least one bolt.

12. The electric motorcycle of claim 1, wherein the at least one footrest support is made of aluminum.
